(19) United States
(12) Patent Application Publication
(10) Pub. No.: US 2015/0293246 A1
(43) Pub. Date: Oct. 15, 2015

(54) FREQUENCY-DOMAIN AUGMENTED TIME-DOMAIN FULL WAVEFIELD INVERSION

(71) Applicants: Thomas A. Dickens, Houston, TX (US); Sunwoong Lee, Houston, TX (US); Yaxun Tang, Spring, TX (US)

(72) Inventors: Thomas A. Dickens, Houston, TX (US); Sunwoong Lee, Houston, TX (US); Yaxun Tang, Spring, TX (US)

(21) Appl. No.: 14/656,389

(22) Filed: Mar. 12, 2015

Related U.S. Application Data
(60) Provisional application No. 61/977,406, filed on Apr. 9, 2014.

(51) Int. Cl. G01V 1/28; G01V 1/30

(52) U.S. Cl. CPC G01V 1/282; G01V 1/303; G01V 1/306; G01V 2210/675; G01V 2210/622

(57) ABSTRACT

A basically time-domain method for performing full wavefield inversion of seismic data to infer a subsurface physical property model (61), where however at least one quantity required for the inversion, such as the Hessian of the cost function, is computed in the frequency domain (64). The frequency-domain quantity or quantities may be obtained at only a few discrete frequencies (62), preferably low frequencies, and may be computed on a coarse spatial grid, thus saving computing time with minimal loss in accuracy. For example, the simulations of predicted data and the broadband gradient of the objective function may be computed in the time domain (67), and the Hessian matrix, approximated by its diagonal, may be computed in the frequency domain. It may be preferable to use time-domain and the frequency-domain solvers that employ different numerical schemes, such as finite-difference method, one-way wave equation, finite-element method (63).

### CROSS-REFERENCE TO RELATED APPLICATION

This application claims the benefit of U.S. Provisional Patent Application 61/977,406, filed Apr. 9, 2014, entitled FREQUENCY-DOMAIN AUGMENTED TIME-DOMAIN FULL WAVEFIELD INVERSION, the entirety of which is incorporated by reference herein.

### FIELD OF THE INVENTION

This disclosure relates generally to the field of geophysical prospecting for, or production of, hydrocarbons and, more particularly, to seismic data processing. Specifically, the disclosure relates to a basically time-domain method for inverting seismic data, e.g. full wavefield inversion (FWI), to infer a subsurface model of a physical property such as velocity, where however at least one quantity required for the inversion, such as the Hessian of the cost function, is computed in the frequency domain. Seismic data inversion is used for exploring for hydrocarbon reservoirs and for developing and producing them.

### BACKGROUND OF THE INVENTION

Full wavefield inversion, a process for determining subsurface properties by iteratively constructing models such that wavefields calculated with those models match measured data, is well known to be a computationally intense task. Each iteration, of which there may be tens to hundreds, requires the solution of the wave equation for each source location, often for multiple times at each iteration to adequately compute the model updates.

The computations required to perform FWI can be carried out in either the time or frequency domain. Each domain has advantages and disadvantages relative to the other. For instance, forward modeling in the time domain (TD) naturally produces the entire time series from each shot containing entire source bandwidth with less computational memory requirement, but is computationally expensive. This computation needs to be repeated as many times as the number of shots in seismic survey, drastically increasing the computational cost of the method.

On the other hand, frequency domain (FD) modeling computes one frequency component at a time with relatively low computational cost, but requires very large computational memory depending upon the method used. Frequency domain methods have additional advantage that the computations may be repeated at many shot locations with very minor added cost, if a matrix factorization approach is used for solution of the Helmholtz equation.

The large memory requirement of the FD FWI has led to the adoption of the TD FWI as the algorithm of choice for most workers. It has been proposed that the time-domain simulation method be used even when FD FWI is desired in order to reduce the memory requirement. This is done by applying discrete Fourier transform to the seismic data simulated by time-domain numerical methods [3].

One of the disadvantages of the time-domain approaches is the difficulty in computing the diagonal of the Hessian matrix. The diagonal of the Hessian matrix contains information on the source and receiver illumination, and can be used to improve the convergence of the inversion.

Each iteration of FWI proceeds by perturbing the previously computed model in a direction designed to decrease the misfit E (often called the objective function or the cost function) between the computed and measured data. The direction used is usually the negative of the gradient vector, which is the derivative of the misfit with respect to the model parameters (e.g., velocity νₚ, density ρ, or attenuation Q). Thus the model parameter m(x) is updated by using the equation

$${m}^{′} ( x ) = m ( x ) - α \frac{\partial E}{\partial m ( x )} , \qquad ( 1 )$$

where α is the step length, which may be optimized with a line-search method.

Often, the iterations can be made to converge faster by preconditioning the search direction (gradient) with the inverse of the matrix of second derivatives of the misfit function, known as the Hessian matrix. This tends to equalize the contributions of model variations at different locations; that is, it may be looked at as undoing the effects of varying illumination in the subsurface. In this case the model update becomes

$${m}^{′} ( x ) = m ( x ) - β {\sum }_{y} {( \frac{{\partial }^{2} E}{\partial m ( x ) \partial m ( y )} )}^{- 1} \frac{\partial E}{\partial m ( y )} , \qquad ( 2 )$$

where β is again a step length that can be optimized; if the misfit function is nearly quadratic, β should be close to one.

However, computing the Hessian, even approximately, is extremely costly using TD methods. Therefore, one often resorts to using simple heuristic approximations such as rescaling the gradient by depth, or one can use some quickly computable semi-analytic approximation to the Hessian operator. Such approximations usually consider only the variation of source illumination, and ignore or approximate the effect of the receiver illumination. Consequently, they may ignore important variations caused by heterogeneity in the model parameters [1, 2].

Another important problem in TD FWI is its application to multi-parameter inversion. For example, one may wish to invert for both νₚ and Qₚ, or νₚ and the VTI anisotropy parameters ε and δ. It is known that the separation of the effects of these parameters is difficult, with the result that inversion will mix the effects of the parameters with each other (known as the cross-talk effect). For instance, applying FWI to update a model having a perfect νₚ but an incorrect ε, for example, will result in an update on both parameters. In addition, the parameters enter the wave equation with very different numerical scales. Their units are quite different and simply inverting for them simultaneously without rescaling leaves the inversion insensitive to the parameters with small scales.

Application of the inverse Hessian to the search directions (gradients) for multi-parameter FWI can help address these issues. First, the inverse Hessian has the effect of rescaling the equations such that all parameters contribute on an equal basis. In addition, this rescaling is done in a spatially varying way that accounts for variations in parameter value and illumination. Second, if one uses the cross terms of the Hessian

$$( terms such as \frac{{\partial }^{2} E}{\partial {v}_{p} \partial {Q}_{p}} )$$

some of the issues with cross talk can be improved.

However, computation of the TD Hessian, particularly in the multi-parameter case, adds significantly to the cost of FWI. In addition, for the case of Q inversion simply computing the gradient with respect to Q is expensive, since one must employ on the order of three or more memory variables, in addition to the usual stresses and velocities, in order to account for the viscoacoustic (or viscoelastic) nature of the wave propagation. Computation of the components of the Hessian involving Q will then be proportionately more expensive.

### SUMMARY OF THE INVENTION

In one embodiment, the invention is a method for inferring a model of velocity or other physical property by iteratively inverting measured seismic data, comprising the following steps, with (a) and (b) performed in either order:

(a) computing, using a computer, a cost function measuring misfit between the measured seismic data and simulated seismic data, and computing a gradient of the cost function with respect to parameters of the model;
(b) computing a Hessian of the cost function;
(c) computing an inverse of the Hessian and multiplying it times the gradient, thereby generating a conditioned gradient; and
(d) using the conditioned gradient to determine an update to the model;
wherein at least one of (a) and (b) is performed in frequency domain, but all other steps are performed in time domain.

For example, where the Hessian is computed in the frequency domain, it may be computed at one or more selected discrete frequencies, preferably two or more frequencies with a weighted average being used for the ensuing time-domain steps.

### BRIEF DESCRIPTION OF THE DRAWINGS

The present invention and its advantages will be better understood by referring to the following detailed description and the attached drawings in which:

FIG. 1 shows velocity difference between the true model and the initial model for a synthetic test example of the present inventive method for performing full wavefield inversion;

FIG. 2 shows the time-domain gradient in the test exercise, preconditioned using a conventional semi-analytic time-domain diagonal Hessian;

FIG. 3 shows the time-domain gradient preconditioned using a frequency-domain finite-difference diagonal Hessian at 4 discrete frequencies according to the present inventive method;

FIG. 4 shows the time-domain gradient preconditioned using a frequency-domain one-way wave equation diagonal Hessian at 4 discrete frequencies according to the present inventive method;

FIG. 5 shows a comparison of the difference velocity model of FIG. 1 and the three preconditioned gradients in FIGS. 2, 3, and 4 at the lateral location marked by the solid lines; and

FIG. 6 is a flow chart showing basic steps in one embodiment of the present inventive method.

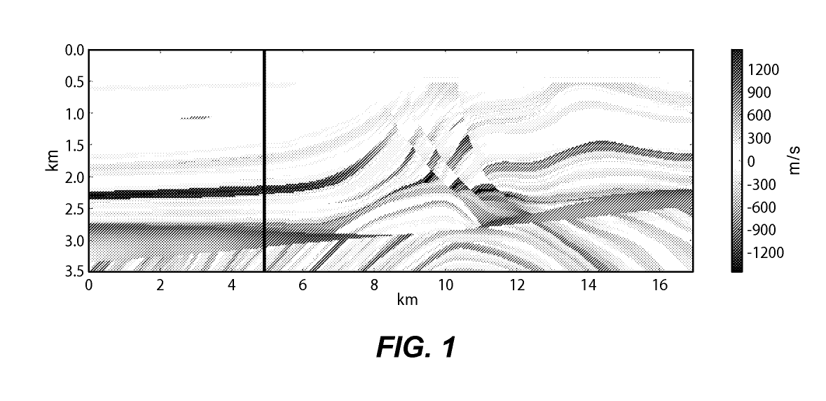

FIGS. 1-4 are black and white reproductions of original color drawings due to patent restrictions on use of color.

The invention will be described in connection with example embodiments. However, to the extent that the following detailed description is specific to a particular embodiment or a particular use of the invention, this is intended to be illustrative only, and is not to be construed as limiting the scope of the invention. On the contrary, it is intended to cover all alternatives, modifications and equivalents that may be included within the scope of the invention, as defined by the appended claims.

### DETAILED DESCRIPTION OF EXAMPLE EMBODIMENTS

The issues outlined in the Background section show that reductions in the cost of computing Hessian operators for TD FWI could lead to performance and convergence improvements for FWI. The present invention addresses this computing cost problem by using a hybrid approach in which these operators are computed using a frequency domain method, where they can be computed more rapidly while avoiding approximations that ignore parameter variations. The computations can potentially be performed using a coarser grid than that employed for the TD simulations, since the preconditioning operator does not need to be defined with the same detail as the model updates in order to provide improvement in convergence. The FD computations can be performed at a frequency or frequencies selected by the user, which do not need to be as high as those used for the TD inversion. In the simplest application of the method, only the diagonal of the Hessian is computed, so that application of its inverse to the gradient simply requires dividing the gradient values by the Hessian values.

The following description of example embodiments of the invention will refer to using a matrix-factorization-based solver for the finite-differenced Helmholtz equation to perform the FD gradient and Hessian computations. However, other approaches could be used, for example the Helmholtz equation could be solved using finite element (FE) or discontinuous Galerkin (DG) methods, or a one-way wave-equation method could be used to compute the Hessian, or a frequency-wavenumber method could be applied with a layer cake approximation to the velocity model. The invention is not limited to a particular type of FD algorithm.

The computation of the diagonal of the (Gauss-Newton) Hessian is straightforward in the frequency domain, consisting of the following sums over source xₛ and receiver xᵣ locations (specifying here the velocity νₚ as the model parameter):

$$H ( x ) = \int H ( x ; f ) d f = \int {\sum }_{{x}_{s}} {\sum }_{{x}_{r} ( {x}_{s} )} {\vert G ( {x}_{s} , x ; f ) \vert}^{2} {\vert G ( x , {x}_{r} ; f ) \vert}^{2} \vert \frac{\partial C ( x )}{\partial {v}_{p} ( x )} \vert d f , \qquad ( 3 )$$

where C(x) is the coefficient term in the Helmholtz equation, f is the frequency, and G is the Green's function in the frequency domain. Using the factorization method (see Reference 4, which is incorporated by reference herein in all jurisdictions that allow it), once the Helmholtz operator for the given model has been factorized, computation of the Green's function at each source or receiver location is very rapid and the Hessian can be computed quickly.

Explicitly, the Helmholtz equation for pressure p(x) is given by

∇²p(x)+C²p(x)=−s(x,ω)), (4)

where the coefficient term C(x) is given by ω/c(x), where c(x) is the phase velocity, which, depending upon the physical parameters included in the model, is a function of some or all of P-wave propagation velocity νₚ, absorption Q, and anisotropy parameters, and where ω=2πf. The term s(x, ω) models the insertion of a source.

An advantageous method for solving the Helmholtz equation involves, as mentioned above, discretizing equation 4 on a grid, factorizing the resulting matrix operator using, for example, an LU algorithm, and storing the resulting factors. Once these are available, equation 4 can be solved very efficiently for any source location, given a fast algorithm for Green's function and Hessian computations in the frequency domain (see Reference 4). That is, Eqn. 4 may be written as

Ap=−s,

where A is the matrix given by discretizing the left hand side of equation 4, and here p is a vector containing the pressure at each grid point. Well-known linear algebra algorithms are used to factor A as A=LU, where L and U are, respectively, lower and upper triangular matrices. This special form allows for rapid solution of the discretized Helmholtz equation. Again, see reference 4 for more detail.

The computation of the diagonal of the Hessian is, using Eq. 3 and Parseval's identity,

$$H ( x ) = \int {\sum }_{{x}_{s}} {\sum }_{{x}_{r} ( {x}_{s} )} {\vert g ( {x}_{s} , x ; t ) ⋆ g ( x , {x}_{r} ; - t ) \vert}^{2} \vert \frac{\partial C ( x )}{\partial {v}_{p} ( x )} \vert d t , \qquad ( 5 )$$

where g is the Green's function in the time domain. Eqn. 5 is specialized, without loss of generality, to acoustic propagation where c(x)=νₚ(x). The frequency domain formulation in Eqn. 3 shows that, while the Hessian for a single frequency component may be computed efficiently using the factorization, accurate Hessian computation requires the computation of the Hessian over the entire frequency band. On the other hand, the time-domain formulation in Eq. 5 shows that, while time domain methods do not require frequency by frequency computation, the Green's function needs to be computed from all the sources and the receivers to each subsurface location x and then needs to be convolved with each other in the time domain.

In the present invention, it is recognized that the frequency-domain Hessian Eq. 3 contains only the magnitude of the Green's function, and so is a slowly varying function of frequency. Therefore, Eq. 3 can be approximated as a discrete sum over a few selected frequencies instead of the frequency integral over the entire frequency band. This computation may then be further approximated using only the low frequency components. Since only a few discrete low frequency components are used in computation, one can now drastically increase the size of the finite difference grids in the frequency domain, and so reduce the memory requirement accordingly. This approximate frequency domain Hessian can then be used to precondition the gradients computed in the time domain using Eq. 2. The approximation could be avoided by transforming the frequency-domain Hessian back to time domain, but at great computational expense. In preferred embodiments of the invention, an average of the frequency-domain Hessians is used. In more preferred embodiments, the average is a weighted average. In even more preferred embodiments, the weighting is by the shape of the spectrum of the time-domain data.

In the next section, results are shown for a TD inversion performed using an FD preconditioner computed as shown here. A constant-density acoustic FWI case is assumed, where the inversion variable is the acoustic velocity νₚ. The method, however, is not limited to the inversion of the velocity, but is generally applicable in multi-parameter inversion where the inversion variables include density, shear velocity, attenuation coefficients, or anisotropy parameters. The method should be particularly suitable for inversion of attenuation and anisotropy parameters, since their spatial frequency of variation is low, and so do not require high resolution in space.

### EXAMPLE

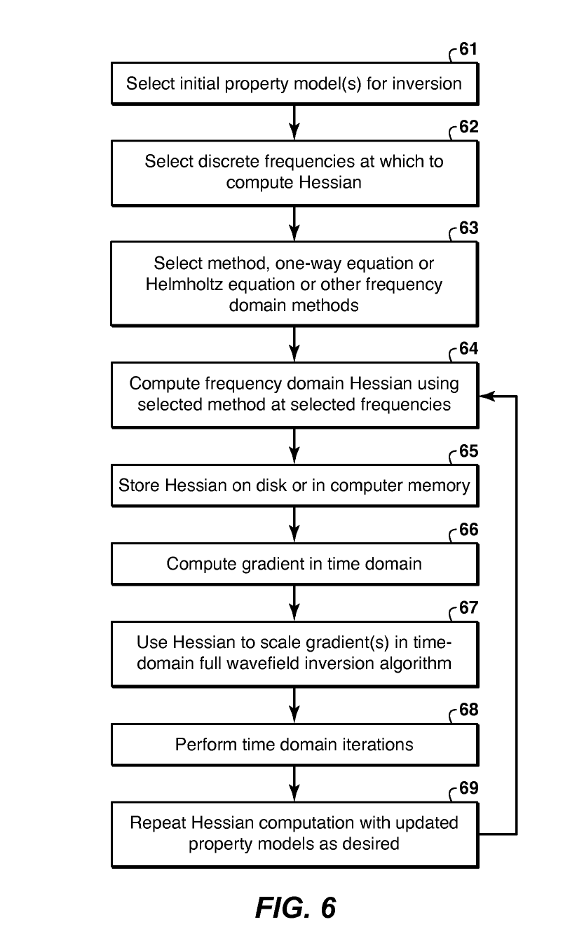

A synthetic example is now presented of preconditioning the time-domain FWI gradient using the frequency-domain Hessian matrix in the Marmousi model (see Ref 5). The application of the present inventive method to this test example may be explained in conjunction with the flow chart of FIG. 6. FIG. 1 shows the difference between the true (Marmousi) velocity model and the initial velocity model (step 61 in FIG. 6). For the simulation of model-predicted data, the source signatures are assumed to be Ricker wavelets with peak frequency of 4 Hz. At step 63, a method is selected for computing the frequency domain Hessian, for example the one-way wave equation, or the Helmholtz equation, or another frequency domain method. Using the selected method in step 64, the frequency-domain diagonal Hessian matrix is computed at discrete frequencies selected at step 62, which for this example were 2, 4, 6, and 8 Hz, to precondition the time domain gradient. (All steps in FIG. 6 do not necessarily have to be performed in the order shown in the drawing). In step 65, the computed Hessians are stored on disc or computer memory to be used in step 67. In step 66, the gradient of the objective function is computed using a time-domain, finite-difference scheme. In step 67, the gradient is preconditioned using the frequency-domain Hessian. In a complete FWI, time domain iterations would be performed (step 68), using the gradient of the objective function (preconditioned by the Hessian) to update the velocity model, and at step 69 the Hessian computation may be repeated (return to step 64) every few iterations or as desired (because the Hessian will change as the model changes). However, the Hessian is not very sensitive to changes in the model, particularly after a small update, so it is typically not necessary to recompute the Hessian using the new model in every iteration.

For the present test exercise, the preconditioned gradient from the present inventive method (step 67) is compared against the preconditioned gradient formed using the conventional semi-analytic time-domain diagonal Hessian that ignores the receiver illumination. The receiver illumination is ignored in the semi-analytic preconditioner due to prohibitive computational cost in time-domain solvers.

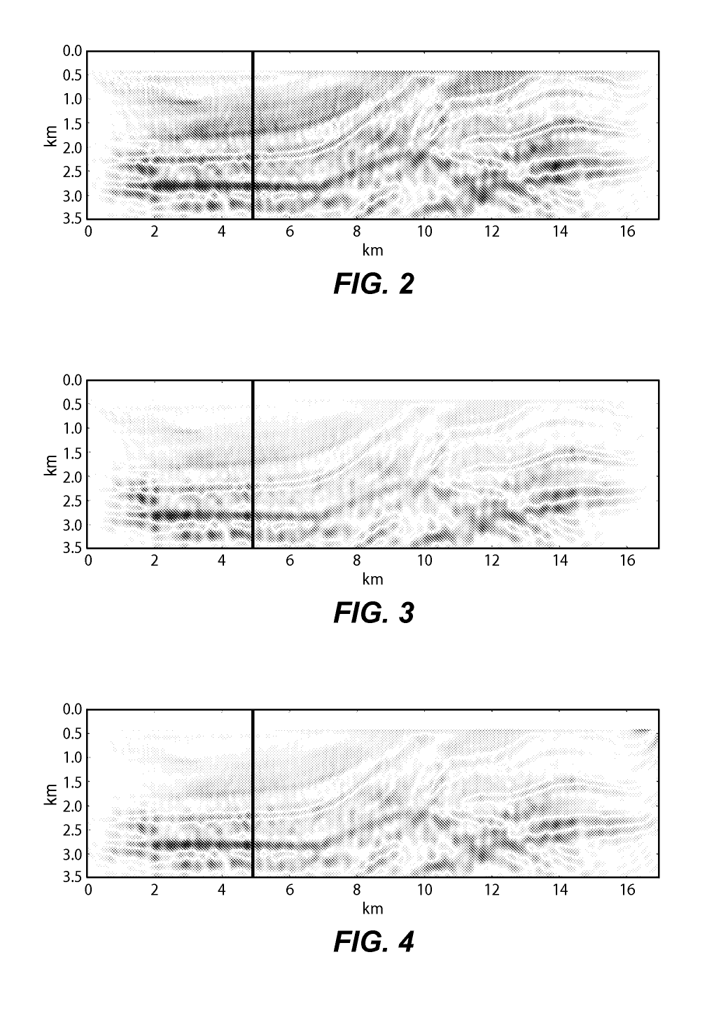

FIG. 2 shows the preconditioned FWI gradient using semi-analytic diagonal Hessian, a conventional technique. FIGS. 3 and 4 show the preconditioned gradients using the frequency domain Hessian of the present invention. In FIG. 3, the Hessian was computed using two-way finite-difference solver. In FIG. 4, the Hessian was computed using one-way wave equation solver to further reduce the compute time. Since the diagonal Hessian does not change from iteration to iteration, one may be able to recompute the diagonal Hessian in the frequency domain once every few iterations, and reduce the compute time even further.

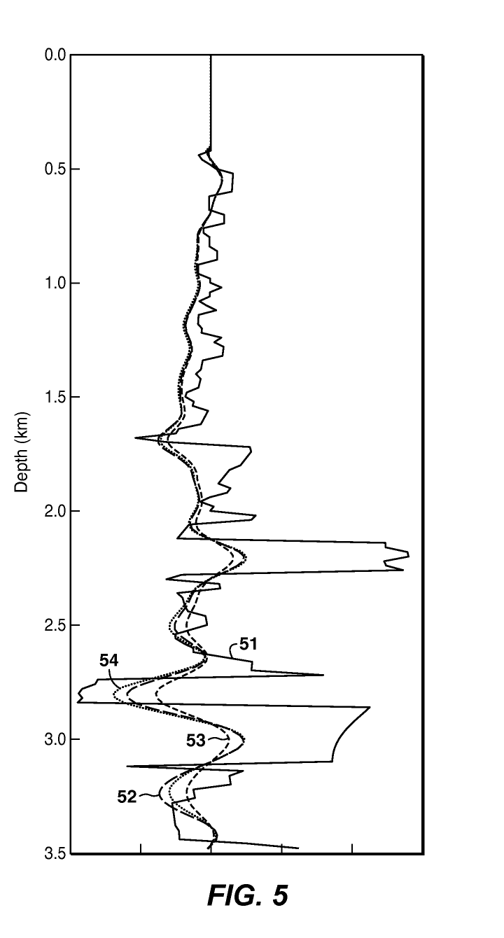

Comparison of the preconditioned gradients in FIGS. 2, 3, and 4 shows good agreement between different preconditioning schemes, even though the frequency-domain preconditioners are computed at only four discrete frequencies. FIG. 5 shows the comparison between these preconditioned gradients in FIGS. 2 to 4 and the difference velocity model in FIG. 1 as a function of depth at a fixed horizontal location marked by the solid vertical lines in FIGS. 1 to 4. In FIG. 5, curve 51 shows the velocity difference from FIG. 1. Curve 52 is the preconditioned gradient using the semi-analytic diagonal Hessian from FIG. 2. Curves 53 and 54 are the preconditioned gradients using the two-way and one-way frequency domain Hessian of the present invention from FIGS. 3 and 4, respectively. A good preconditioner for the inversion should be able to make the amplitude of the preconditioned gradients proportional to the velocity difference of the subsurface, so that when a line search is performed using Eq. 2, the updated model is closer to the true model in the entire region of the inversion. It can be seen that, while the preconditioned gradients are qualitatively similar, the preconditioned gradient using the semi-analytic preconditioner shows weaker gradient amplitudes in the deep section of the model. This is due to the fact that the semi-analytic preconditioner using a time-domain solver has neglected the contribution of the receiver illumination, which is included in the frequency-domain preconditioned gradients.

In summary, key aspects of the invention include the following:

(1) A frequency domain method is used, potentially on a relatively coarse grid, to compute quantities that may be used to reduce computation time and/or improve quality of a time-domain inversion.

(2) A particular quantity advantageously computed in the frequency domain in this manner is the second-derivative matrix (Hessian), which may be used to precondition time domain FWI, improving convergence and accuracy.

(3) Another quantity advantageously computed in the frequency domain in this manner is the gradient vector (of the misfit), which may be used to give the search direction for time-domain FWI, particularly for slowly varying parameters like Q or (ε, δ) in a multi-parameter TD FWI.

(4) The FD computations may be performed by a number of different methods, among them solution of the FD Helmholtz equation by factorization or iterative methods, use of f-x domain one-way solvers, or wavenumber solutions for layered media.

The foregoing description is directed to particular embodiments of the present invention for the purpose of illustrating it. It will be apparent, however, to one skilled in the art, that many modifications and variations to the embodiments described herein are possible. All such modifications and variations are intended to be within the scope of the present invention, as defined by the appended claims.

### REFERENCES

[1] Chavent and R.-E. Plessix, “An optimal true-amplitude least-squares prestack depth-migration operator,” Geophysics 64(2), 508-515 (1999).
[2] Lee, J. R. Krebs, J. E. Anderson, A. Baumstein, and D. Hinkley, “Methods for subsurface parameter estimation in full wavefield inversion and reverse-time migration,” 80th Annual International Meeting, SEG, Expanded Abstract (2010).
[3] Sirgue, J. Etgen, U. Albertin, and S. Brandsberg-Dahl, “System and method for 3D frequency domain waveform inversion based on 3D time-domain forward modeling,” U.S. Pat. No. 7,725,266 (2010).
[4] Shen Wang, Maarten V. de Hoop, Jianlin Xia, “Acoustic inverse scattering via Helmholtz operator factorization and optimization,” Journal of Computational Physics 229, 8445-8462 (2010).
[5] Laurent Sirgue and R. Gerhard Pratt, “Efficient waveform inversion and imaging: A strategy for selecting temporal frequencies,” Geophysics 69, 231-248 (2004).

1. A method for inferring a model of velocity or other physical property by iteratively inverting measured seismic data, comprising the following steps, with (a) and (b) performed in either order:
(a) computing, using a computer, a cost function measuring misfit between the measured seismic data and simulated seismic data, and computing a gradient of the cost function with respect to parameters of the model;
(b) computing a Hessian of the cost function;
(c) computing an inverse of the Hessian and multiplying it times the gradient, thereby generating a conditioned gradient;
(d) using the conditioned gradient to determine an update to the model; and
(e) using the updated model to prospect for or produce hydrocarbons;
wherein at least one of (a) and (b) is performed in frequency domain, but all other steps are performed in time domain.

2. The method of claim 1, wherein frequency-domain computations are carried out at one or more selected discrete frequencies.

3. The method of claim 2, wherein frequency-domain computations are carried out at two or more selected discrete frequencies, and a weighted average is used.

4. The method of claim 2, wherein frequency-domain computations and time-domain computations are carried out using selected spatial computational grids, and the grid for the frequency-domain computations is coarser than the grid for the time-domain computations.

5. The method of claim 4, wherein a cutoff frequency is selected, and only those discrete frequencies below the cutoff frequency are used in the frequency domain computations.

6. The method of claim 1, wherein the model being inferred is a model of at least one of the following physical properties: P-wave velocity, density, shear velocity, attenuation coefficients, and anisotropy parameters.

7. The method of claim 6, wherein at least two physical properties are inferred in the inversion.

8. The method of claim 1, wherein only diagonal values of the Hessian are computed.

9. The method of claim 1, wherein if (a) or (b) is performed in time domain, that comprises solving a wave propagation equation to generate simulated seismic data for the cost function; and if (a) or (b) is performed in frequency domain, that comprises solving the Helmholtz equation to generate simulated seismic data for the cost function.

10. The method of claim 9, wherein one of (a) or (b) is performed in time domain and the other is performed in frequency domain, and (a) and (b) employ different numerical schemes selected from a group consisting of a finite-difference method, a one-way wave equation, and a finite-element method.

11. The method of claim 1, wherein (d) is performed by a line search.

12. The method of claim 1, wherein the performing of at least one of (a) and (b) in frequency domain comprises solving the Helmholtz equation by matrix factorization.
